(19) United States
(12) Patent Application Publication
(10) Pub. No.: US 2025/0303910 A1
(43) Pub. Date: Oct. 2, 2025

(54) METHOD FOR TRANSFERRING DATA TO A NETWORK OPERATOR FOR A PREDICTION MODEL

(71) Applicant: Magna International Europe GmbH, Wien (AT)

(72) Inventor: Gerald Teuschl, Fernitz-Mellach (AT)

(21) Appl. No.: 18/881,501

(22) PCT Filed: Jun. 5, 2023
(86) PCT No.: PCT/EP2023/065005

§ 371 Date: Jan. 6, 2025

(30) Foreign Application Priority Data
Jul. 7, 2022 (DE) 10 2022 206 962.5

(51) Int. Cl. B60L 53/63; B60L 55/00; G06Q 30/0202

(52) U.S. Cl. CPC B60L 53/63; B60L 55/00; G06Q 30/0202

(57) ABSTRACT

A method for transferring data to a network operator for a prediction model, wherein there is a network operator interface and the data and information from model calculations are used, wherein, in addition to historical data, individual data relating to at least one end user of an electric vehicle is included in the model calculation for prediction purposes.

### CROSS-REFERENCE TO RELATED APPLICATIONS

This application is a National Stage of International Application No. PCT/EP2023/065005, filed Jun. 5, 2023, which claims priority to DE 102022206962.5 filed Jul. 7, 2022. The entire disclosures of each of the above applications are incorporated herein by reference.

### FIELD OF THE INVENTION

The invention relates to a method for transferring data to a network operator for a prediction model, wherein there is a network operator interface and the data and information from model calculations are used.

The invention also relates to a service package for a network operator as well as a business model for offering and commercially distributing calculated data from a prediction model.

### BACKGROUND OF THE INVENTION

This section provides information related to the present disclosure which is not necessarily prior art.

Renewable energy sources are becoming increasingly important, but their feed-in into the grids fluctuates and does not run in parallel with the development of the demand for energy. Electric vehicles can make a decisive contribution to solving the resulting problems. This is because storage technologies are required to exploit the potential of renewable energies. The batteries of electric vehicles are ideal for this. Electromobility and grid integration are therefore an essential pillar of sustainable mobility and at the same time a central political field of action.

The energy flow between the grid and the electric vehicle can take place in two directions when the vehicle is used as a mobile storage system: In times of energy surplus, the vehicle batteries can be used as storage in the grid-to-vehicle (G2V) direction, whereas in times of high energy demand, the energy can be released back to the grid in the vehicle-to-grid (V2G) direction. However, the term vehicle-to-grid (V2G) is also used—especially internationally—for the overarching concept of grid integration of electric vehicles, which integrates the two flow directions “from grid to vehicle” and “from vehicle to grid”.

Vehicle-to-grid is a concept for releasing electrical current from the traction batteries of electric and hybrid cars back into the public power grid. Vehicle-to-home works according to the same principle, but here the electricity is not fed back into the public grid, but into the private home power grid.

Both concepts require that the charging station can control the energy bidirectionally. In contrast to conventional electric vehicles, bidirectional charging vehicles can not only absorb electrical energy from the grid, but also feed electricity from the car battery into the grid or home in the opposite direction via special charging stations in times of high grid utilization as part of an intelligent energy system.

Vehicle-to-grid is considered an essential key to the energy supply of the future—for several reasons: More and more electric cars are rolling on German and European roads and ensuring that the demand for electricity increases. At the same time, however, more and more power plants feeding in constant amounts of electricity will be taken off the grid in the medium term. These include nuclear and coal-fired power plants in particular. As part of the energy transition, they are being replaced by renewable energy, especially wind turbines and solar energy. Both are very susceptible to fluctuations, as with the electricity mix for Germany shows, for example.

The many electric cars are considered part of the solution to these fluctuations: The vehicle to grid (V2G) concept is based on electric cars absorbing excess electricity and feeding it back into the grid later when there is a shortage of electricity.

A pilot trial by Porsche and the transmission system operator TransnetBW has become known, wherein the high-voltage batteries of electric cars can be used as intelligent buffer storage.

The core element of the data communication in the pilot trial is a cloud-based pooling system developed by IE2S. This coordinates the charging processes of the electric vehicles. In doing so, it translates the network operator's control power setpoints into vehicle-specific signals that control the charging processes in real time. In addition, the pooling system controls the high-frequency and time-synchronous bidirectional data transport.

A major risk and a high factor of the uncertainty for the grid operation of the network operators involved is represented by new loads due, for example, to times of charging processes of electric vehicles that cannot be influenced. It is therefore crucial for the network operator to know how many electric vehicles are charging in its network.

One source of the information for the network operator is a monitoring of the electric vehicle models on the market, or their market ramp-up. The data will be used to enable network operators to prepare their grids accordingly for the ramp-up of electric vehicles and to provide them with better planning security.

However, since not all charging processes and the resulting loads for the network operator can be planned, it is necessary to create legal and technical possibilities for the integration of intelligent charging and load management. This makes it possible to stagger the charging processes and relieve the grid if necessary.

A large number of approaches are being discussed to this influencing of the charging processes, from local load management to bidirectional charging.

The following terms are important for grid management:

Grid compatibility refers to the basic prerequisite for connecting a system to the public power grid. It forms the basis for grid serviceability and system serviceability. System serviceability contributes to maintaining the stability of the electricity system and is mainly initiated by the transmission system operators.

To illustrate the definition of grid integration set out above, the two terms grid compatibility and grid integration are applied to the current situation.

In the case of grid compatibility, load or charging management is already taking place on the part of the customer—especially in the commercial sector—in order for the subscriber to comply with the contractual obligations agreed with the network operator. In this case, there is no intervention or control of the customer system by the network operator, so that it does not influence the current output.

Today, grid service is usually implemented on the basis of an agreement between the network operator and the subscriber in accordance with Section 14a of the Energy Industry Act in Germany (EnWG). Against the background of its load monitoring, the network operator influences the load behavior of the subscriber, for example through time/load windows, ad-hoc control signals and financial incentives. In this case, the customer system implements the corresponding information from the network operator. The network operator's financial incentives are passed on to the subscriber in the form of reduced grid usage fees by the supplier/aggregator.

Currently, there is central control of the grid interconnection of the network operators and the associated demand control of the energy feed-in based on usage prediction models. These models can be rated as mature and reliable. Due to the increase in mobile high-current and energy consumers such as battery-electric vehicles, these anticipatory switchovers (re-/dispatch) and power adjustments are increasingly disrupted.

Resulting defects in the electrical grid, such as increases in energy costs due to additional grid expansion requirements, instability of the grid, negative impact on customers, as the vehicles can be taken off the grid and thus the charge can be interrupted unexpectedly, and low predictability of the grid configuration and grid load due to locally, regionally and supra-regionally moving loads and the resulting increase in infrastructure costs and environmental impacts.

### SUMMARY OF THE INVENTION

This section provides a general summary of the disclosure, and is not a comprehensive disclosure of its full scope or all of its features.

It is the object of the invention is to provide an improved prediction of the future location-related grid power demand and energy demand of the mobile consumers connected to the system.

The object is achieved with a method for the transfer of data to a network operator for a prediction model, wherein there is a network operator interface and the data and information from model calculations are used, wherein, in addition to historical data, individual data of at least one end user of an electric vehicle are included in the model calculation for prediction.

The data for prediction can clearly be improved if end-users provide up-to-date data. In addition to the previously known prediction models, which only use historical data, here there is a component based on individual end customers.

The object is also achieved with a method for the transfer of data to a network operator for a prediction model, wherein there is a network operator interface and the data and information from model calculations of an environment model and a fleet model are collected for a predefined network area, wherein the fleet model receives sub models of a customer preferences user model, a usage group model, a charging station model, a vehicle model and a driver model.

The large number of models used model a data image from the large amount of available data that the network operator uses for their prediction.

In detail, the prediction model contains the environment model, which contains information about the current local weather from the vehicles and is also able to represent a route of an electric vehicle in the area of the predefined grid area and can use the road loading along the route as a parameter.

In detail, the prediction model contains the user model, the customer preferences includes at least information about the use of the electric vehicle against time and the known and most likely driving routes thereof, situational reactions to traffic events, and charging behavior data.

In detail, the prediction model contains data about charging behavior, which is automatically recognized as charging profiles and/or a data collection is provided for the user, wherein a customer interface is used for entering preferences for charging points, distance from the destination, charging profiles adjusted in terms of charging time, charging energy, and charging power.

In detail, the prediction model contains the usage group model, which is dynamically built up by means of correlation of similar usage groups and/or similar user behavior.

In detail, the prediction model contains the charging station model, which provides the weather, occupancy data, function and performance data as well as type information of the charging stations.

In detail, the prediction model contains the vehicle model, which is used to determine the state of charge at the end of the journey, which is also based on a prediction.

In detail, the prediction model contains the driver model, which allows an even better estimate of the expected energy consumption for determining the expected route and the individual driving behavior.

The object is also achieved with a method wherein the fleet model aggregates the available and calculated data of the individual models, customer preferences user model, usage group model, charging station model, vehicle model and driver model in order to provide the network operator interface with a prediction of the expected future, location-related power and energy demand. The object is also achieved with a service package. The object is also achieved with a prediction model consisting of data from calculated models and compiled into a prediction model that is made available to network operators for their grid operation.

The object is also achieved with a business model for offering and commercially distributing calculated data from a prediction model for a network operator.

The method minimizes grid and energy costs through better prediction and optimizes consumption and thus CO2 emissions.

The improved prediction leads to improved grid stability and a reduction in grid failure probabilities.

The customer has the advantage that it is less likely that their charging process will be switched off.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an embodiment of the invention according to an aspect of the disclosure.

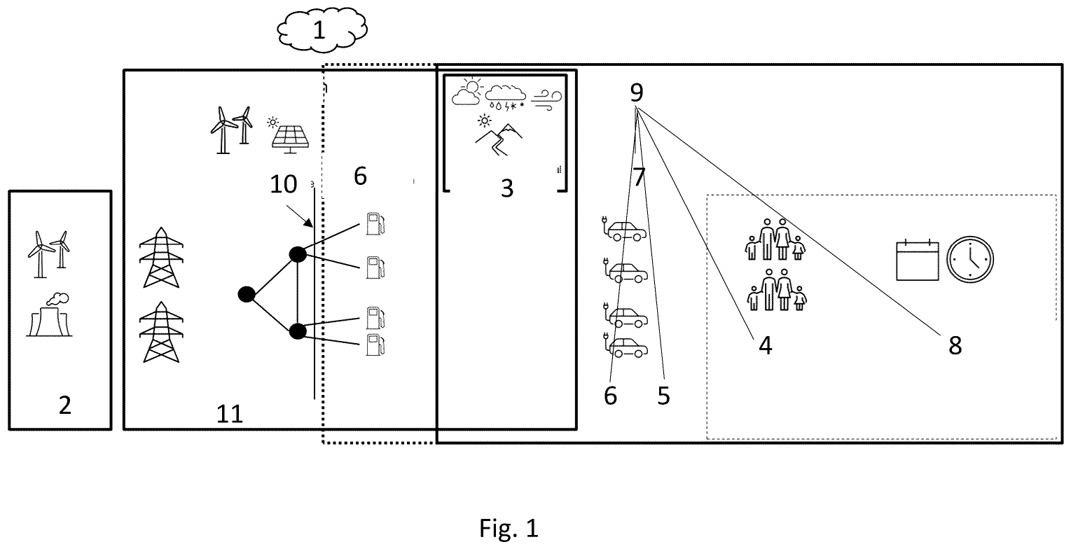

### DESCRIPTION OF THE INVENTION

Both classical and the new intellectual and modelling approaches to prediction are among the model-theoretical methods. The objective of a model is the systematic investigation and description of relationships between influencing variables and variables of interest.

A prognosis of the future progression of the variable of interest of the system as a function of the influencing variables follows the modelling.

The prediction model in the system of the network operator 1 for the energy demand is linked to the information of the energy supplier 2 on the energy side. There are also decentralized generators, which are divided into two categories, the controllable generators and the non-controllable generators.

While combined heat and power plants represent the controllable generators, wind farms and photovoltaic systems are among the non-controllable decentralized generators.

For the prediction, the focus is on the non-controllable decentralized generators. Prediction models can be used to determine their electricity generation a certain time in advance. This makes it possible to schedule the electric vehicles to charge at times of high production and to interrupt charging when little electricity is produced. If, for example, the photovoltaic system or wind farm is part of a company complex, the own electricity consumption of the company can also be increased. The prediction of the planned generation is highly dependent on the weather prediction models. For example, wind speed determines the electricity generation of wind turbines. Likewise, the electricity generation of solar systems varies depending on the irradiation duration, the intensity and the angle of incidence of the solar radiation. As a result, generation from renewable energy sources can change significantly within a short period of time, for example in the case of photovoltaic systems due to clouds obscuring the sun. Weather forecasts can be used to predict such fluctuations and thus plan for them at an early stage, but the accuracy of such forecasts is limited. This can lead to instabilities in the grid, which can be absorbed by the skillful use of flexible loads.

The prediction model according to the invention is based on data and sub models collected from electric vehicles and for which sub models serve as a starting point. The prerequisite for this is rechargeable vehicles with the possibility of providing information about their position, the destination, the user or their behavior and the user preferences.

Other data of the electric vehicle are also the type of vehicle, with information about the model, battery size and power, and power status information that represents the need for charging or the possibility of discharging.

In addition, an environment model 3 is used for the prediction model 1, which contains information about the current local weather from the vehicles. The environment model 3 is also able to represent a route of an electric vehicle in the area of the grid and can use the road loading along the route as a parameter.

In addition to the individually collected data of an individual user of an electric vehicle, a customer preferences user model 4 is used. This customer preferences user model 4 includes at least information about the usage against time and the known and most likely routes of the electric vehicle. This results in driving profiles in terms of power, energy consumed and the route segment, for example information about gradients. The situational response, such as route loading data response, is also recorded. This allows a regular route to be adjusted if a traffic jam occurs and the user always takes the same alternative route.

The customer preferences 4 user model also receives data about charging behavior. Charging profiles are recognized automatically. It is also intended as an addition or as sole data collection that a customer interface is used to enter preferences for charging points, distance from the destination, charging profiles adjusted in terms of charging time, charging energy, and charging power.

The prediction model 1 also uses a usage group model 5, which is dynamically constructed by means of correlation of similar usage groups and/or similar user behavior.

Another sub model is a charging station model 6, which provides weather, occupancy data, function and power data as well as type information of the charging stations.

One sub model represents a vehicle model 7 for determining the state of charge at the end of the journey, which is also based on a prediction.

A driver model 8 for determining the expected route and the individual driving behavior allows an even better estimate of the expected energy consumption.

The information and results of the sub models are combined in a fleet model 9, which aggregates the available and calculated data in order to provide and transfer a prediction of the expected location-related power and energy demand to the network operator interface 10.

The prediction model 1 is populated with data based on the data of the fleet model 9, which is carried out via a cloud-based system for calculating the models.

The network operator 11 itself provides a network operator interface 10 for reading the expected network loading by means of the mobile loads connected to the system.

The data for the prediction model are transferred to the network operator as a service package. As a supplier, this allows you to sell data to the network operator.

The collection of the data in the manner described above, the calculation of models, the combination of the models and the final calculation are all carried out via Internet connections in the network.

### REFERENCES

1 Prediction model
2 Energy supplier
3 Environment model
4 Customer preferences user model
5 Usage group model
6 Charging station model
7 Vehicle model
8 Driver model
9 Fleet model
10 Network operator Interface
11 Network operator

What is claimed is:

1. A method for transferring data to a network operator for a prediction model, wherein there is a network operator interface and the data and information from model calculations are used, wherein, in addition to historical data, individual data of at least one end user of an electric vehicle are included in the model calculation for the prediction.

2. The method for the transfer of data to a network operator for a prediction model as claimed in claim 1, wherein there is a network operator interface and the data and information from model calculations are collected from an environment model and a fleet model for a predefined network area, wherein the fleet model receives sub models from a customer preferences user model, a usage group model, a charging station model, a vehicle model and a driver model.

3. The method as claimed in claim 1, wherein the environment model contains information about the current local weather from the vehicles and is also able to represent a route of an electric vehicle in the area of the predefined network area and to use the road loading along the route as a parameter.

4. The method as claimed in claim 1, wherein the customer preferences user model contains at least information about the use of the electric vehicle against time and the known and most likely driving routes, situational reactions to traffic events, and charging behavior data thereof.

5. The method as claimed in claim 4, wherein data about charging behavior are automatically recognized as charging profiles and/or data acquisition is provided for the user, wherein a customer interface is used to enter the preferences for charging points, distance from the destination, charging profiles adjusted in terms of charging time, charging energy, and charging power.

6. The method as claimed in claim 1, wherein the usage group model is dynamically constructed by means of correlation of similar usage groups and/or similar user behavior.

7. The method as claimed in claim 1, wherein the charging station model provides the weather, occupancy data, function and performance data and type information of the charging stations.

8. The method as claimed in claim 1, wherein the vehicle model is used for determining the state of charge at the end of the journey, which is also based on a prediction.

9. The method as claimed in claim 1, wherein the driver model allows an even better estimate of the expected energy consumption for determining the expected route and the individual driving behavior.

10. The method as claimed in claim 1, wherein the fleet model aggregates the available and calculated data of the individual models, customer preferences user model, usage group model, charging station model, vehicle model and driver model in order to provide the network operator interface with a prediction of the expected future location-related power and energy demand.

11. A service package created using the method as claimed in claim 1, consisting of data from calculated models and compiled into a prediction model which is made available to network operators for their network operation.

12. A business model for offering and commercially distributing calculated data from a prediction model as claimed in claim 1 for a network operator.
